(19) United States
(12) Patent Application Publication
(10) Pub. No.: US 2020/0146509 A1
(43) Pub. Date: May 14, 2020

(54) MAGNETIC MIXING APPARATUS

(71) Applicant: Raison Investments Inc., New Westminster (CA)

(72) Inventor: Charn Rai, New Westminster (CA)

(73) Assignee: Raison Investments Inc., New Westminster (CA)

(21) Appl. No.: 16/708,358

(22) Filed: Dec. 9, 2019

Related U.S. Application Data
(62) Division of application No. 15/744,013, filed on Jan. 11, 2018.
(60) Provisional application No. 62/191,965, filed on Jul. 13, 2015.

(51) Int. Cl. A47J 43/046; B01F 13/08; B01F 13/00

(52) U.S. Cl. CPC A47J 43/0465; B01F 2215/0072; B01F 13/0022; B01F 13/0818

(57) ABSTRACT

A container having a captive rotatable magnet to induce spinning of a separate unattached stirring implement placed in the container. The captive rotatable magnet may be part of an active mixer attached to the container. It may also be passively housed in a chamber in the bottom of the container to be spun under the influence of an external mixer to transmit by coupling the spinning to the separate spinning implement. The stirring implement is magnetically retained within the container during the pouring of a mixed substance.

This application is a divisional application of U.S. application Ser. No. 15/744,013, filed Jan. 11, 2018, which is a U.S. National Phase application of International Application No. PCT/CA2016/050819, filed Jul. 12, 2016, which claims priority to U.S. Provisional Application Ser. No. 62/191,965 filed Jul. 13, 2015, all of which are herein incorporated by reference in their entireties.

### BACKGROUND OF THE INVENTION

### Field of the Invention

This invention relates to a magnetic mixing apparatus. In particular, this invention relates to a magnetic mixing apparatus that may be used in the food and beverage industry, in laboratories, and in other applications.

### Description of the Related Art

Mixing devices are commonly used in the preparation of food or drinks. For example, a conventional household blender has a base unit containing a motor and a container attachable to the base unit. When the container is placed on the base unit, one or more blades fixed to the base of the container mechanically couple to drive means in the base unit. Due to such mechanical coupling means, the base of the container is often not flat making it difficult to clean after mixing is complete. Structures at the base of the container are also known to result in leaking problems due to damage and wear.

Some blenders or mixers attempt to avoid the challenges of cleaning blade coupling means such as in U.S. Pat. No. 7,766,540 to Saunders et al. which discloses a blender wherein the motor and electrical components are enclosed in the top compartment rather than in a base unit.

Magnetic stirrers are commonly used in chemistry and biology laboratories. Typically a beaker or flask is placed on top of a magnetic stirrer that generates a rotating magnetic field. A magnetic stir bar and the solution to be mixed are placed into the container. When the magnetic stirrer is powered, the magnetic stir bar spins to mix the contents in the container. Once mixing is complete, the magnetic stirring bar is removed from the flask using a retriever (rod with a magnet at one end). However if the magnet stirring bar is not removed prior to pouring the contents from the container, gravity and entrainment by the solution may cause the stir bar to spill out of the container. If such magnetic stirrers are used to prepare beverages or food substances, the stir bar may also present a choking hazard.

U.S. Pat. No. 7,314,307 to Cai and U.S. Pat. No. 8,480,292 to Dushine disclose mixing by magnetic means. While Cai and Dushine overcome leaking problems with prior art blenders, cleaning is still difficult due to the presence of mixing and other elements protruding from the base of the container.

U.S. Patent Application Publication No. 2010/0018403 to Hoare discloses a magnetic means of raising and lowering a tea basket. However the magnetic raising and lowering means is complex requiring a motor, gears, and a screw, belt, or chain. Such complex arrangements are expensive and prone to wear and failure.

It is the object of the present invention to provide a magnetic mixing assembly that includes an unattached, removable stirring implement that does not fall out when the container is emptied by pouring.

It is a further object of the invention to provide a magnetic stirring implement suitable for use as an unattached, magnetic stirring implement for the bottom of a container.

It is a further object of the invention to provide a tea infusion system actuated by the vortex created by a magnetic stirring implement, including means for selectively withdrawing a tea infuser from the water.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### BRIEF SUMMARY OF THE INVENTION

According to one aspect, the invention comprises a container assembly for receiving and mixing fluids wherein the container is fitted with a captive rotatable magnet that may be retained on the container during use. A separate unattached magnetic stirring implement is used in the container to undergo rotation under the influence of the magnetic field of the captive rotatable magnet to thereby stir the contents of the container. As the captive rotatable magnet remains attached to the container during use, the stirring implement remains coupled to it when pouring the contents out of the container.

The captive rotatable magnet may be part of an active drive mechanism attached to the bottom of the container, or it may be retained in a chamber at the bottom of the container to be actuated by proximity to a separate mixer. In the latter case, the captive rotatable magnet reacts to the mixer and the stirring implement reacts to the rotating captive magnet.

In a preferred embodiment, the stirring implement is disc-shaped and contains a magnetic dipole. The stirring implement may also contain one or more projections to reduce the surface area of the magnetic stir bar in contact with the base of the container in order to minimize friction while spinning. Once mixing is complete, a user may immediately drink from the container or pour the contents of the container out without the need to first remove the stirring implement since it will be retained at the base of the container through magnetic coupling with the captive rotatable magnet.

In a further embodiment, the magnetic mixing means may be used with a tea infuser to reduce the time required for steeping tea. A vortex created by a spinning magnetic stirrer element causes water within the container to permeate through the infuser at a more rapid rate than without mixing. The infuser may also be raised about the water after steeping by magnetic means.

According to another aspect, the invention comprises a container assembly with a magnetic stirrer attached to the base of the container. The magnetic stirrer magnetically couples with a stirring implement placed in the container.

In another aspect, a container assembly comprises a container having a bottom and a magnetic stirring unit attached to the container under the bottom. The bottom has an inside bottom surface and an outside bottom surface. The inside bottom surface lacks physical magnet attachment means and lacks physical magnet retention means. The magnetic stirrer has means for causing a rotating magnetic field across the bottom.

In another aspect, a container assembly comprises a container having a bottom and a base unit attached to the container under the bottom. The bottom has an inside bottom surface and an outside bottom surface. The inside bottom surface lacks physical magnet attachment means and lacks physical magnet retention means. The base unit comprises a compartment and a magnet retained within the compartment wherein the magnetic is capable of rotating in place parallel to the bottom of the container.

In a further aspect, the invention is a base unit comprising a compartment having a substantially flat top surface, a magnet retained within the compartment capable of rotating in a plane parallel to the substantially flat top surface of the compartment, and means for attaching the compartment under the bottom of a container.

In another aspect, the invention is a steeping device. The steeping device comprises a container, a handle connected to the peripheral surface of the container, a container magnet connected to the handle wherein the container magnet is vertically slidable on the handle, and pivot means on the handle for pivoting the handle in relation to the container.

In another aspect, the invention is a method of steeping tea. The method comprises placing hot water in a container, placing a magnetic stirring implement in the container, placing an infuser holding tea and having an infuser magnet in the container, powering a magnetic stirrer located under the container to create a rotating magnetic field, and raising the infuser above the hot water by magnetic coupling to the infuser magnet. The rotating magnetic field causes the magnetic stirring implement to spin within the container.

In a further aspect, the invention is a container comprising a base, an opening defining the top of the container, a wall extending between the base and the opening, and a ferromagnetic ring connected to the wall and having substantially the same curvature of the wall.

In another aspect, the invention is a container assembly for receiving and mixing fluids. The container assembly comprises a container having a base, a captive rotatable magnet within an enclosure under the base, and an unattached magnetic stirring implement for resting on the base and for coupling to the captive rotatable magnet. The implement is adapted to rotate when the captive rotatable magnet rotates and the assembly is configured such that the implement is magnetically retained by coupling to the captive rotatable magnet when the container is tilted for pouring the contents from the container.

In another aspect, the invention is a ferromagnetic ring comprising a stretchable ring-shaped casing and a series of magnets within the casing. The casing may be made of silicone. The stretchable magnetic ring is placed about the outside of a container and magnetically retains a magnetic stirring implement within the container during the pouring of contents contained in the container.

In a further aspect, the invention is a container comprising a base, an opening defining the top of the container, and a wall extending between the base and the opening. A portion of the wall is magnetic.

In another aspect, the invention is a method of mixing one or more substances. In the method, a container is provided. The container has a base, an opening defining the top of the container, and a wall extending between the base and the opening. One or more substances and a magnetic stirring implement are placed within the container. A magnetic stirrer located under the container is powered to create a rotating magnetic field. This causes the magnetic stirring implement to spin within the container to create a mixed substance. The mixed substance is poured out of the container. During pouring, the magnetic stirring implement is magnetically retained within the container.

The magnetic stirring implement may be magnetically retained by a ferromagnetic ring integrated within the wall of the container, by a stretchable ferromagnetic ring placed about the wall of the container, or by a magnetic portion of the wall of the container. In the method using a stretchable ferromagnetic ring to retain the magnetic stirring implement, the ring is placed about the wall of the container.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

The invention will be described by reference to the detailed description of the preferred embodiment and to the drawings thereof in which:

FIG. 1 is a perspective view of one embodiment of the magnetic mixing apparatus.

FIG. 2 is a front view of a second embodiment of the magnetic mixing apparatus.

FIG. 3 is a perspective view of the base unit of the apparatus shown in FIG. 2.

FIG. 4A is a perspective view of a disc-shaped stirring implement.

FIG. 4B is a front view of a disc-shaped stirring implement shown in FIG. 4A.

FIG. 4C is a cross-sectional view of the disc-shaped stirring implement shown in FIG. 4A, taken along line 4C of FIG. 4A.

FIG. 5 is a front view of a tea infuser.

FIG. 6A is a perspective view of a third embodiment of the magnetic mixing apparatus showing liquid and the tea infuser of FIG. 5 in a container before mixing.

FIG. 6B is a perspective view of the third embodiment during mixing.

FIG. 6C is a perspective view of the third embodiment after mixing.

FIG. 7 is a perspective view of a fourth embodiment of the magnetic mixing apparatus.

FIG. 8 is a front view of the mixing apparatus illustrated in FIG. 2 pouring liquid from the apparatus.

FIG. 9 is a perspective view of a fifth embodiment of the magnetic mixing apparatus showing a container with a ferromagnetic ring.

FIG. 10 is a perspective view of a removable ferromagnetic ring.

FIG. 11 is a cross-sectional view of the removable ferromagnetic ring shown in FIG. 10.

FIG. 12 is a perspective view of the magnetic mixing apparatus illustrated in FIG. 9 pouring liquid from the apparatus.

FIG. 13 is a perspective view of a sixth embodiment of the magnetic mixing apparatus showing a container with an upper magnetic portion.

FIG. 14 is a perspective view of a seventh embodiment of the magnetic mixing apparatus.

FIG. 15 is a cross-sectional view of the magnetic mixing apparatus illustrated in FIG. 14.

FIG. 16 is a cross-sectional view of the mixing apparatus illustrated in FIG. 14 pouring liquid from the apparatus.

FIG. 17 is a perspective view of an eighth embodiment of the magnetic mixing apparatus.

FIG. 18 is a cross-sectional view of the magnetic mixing apparatus illustrated in FIG. 17.

FIG. 19 is a cross-sectional view of the mixing apparatus illustrated in FIG. 17 pouring liquid from the apparatus.

### DETAILED DESCRIPTION OF THE INVENTION

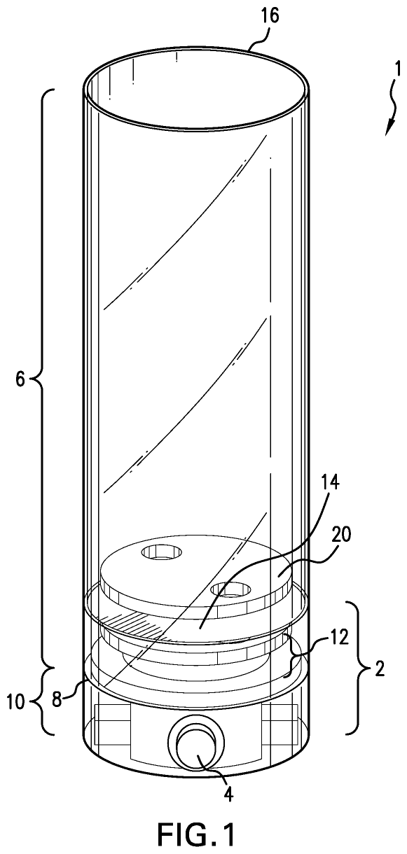

FIG. 1 shows a container 1 with a magnetic stirrer 2 attached to the bottom of the container 1 according to one embodiment of the invention. The magnetic stirrer 2 generates a rotating magnetic field by means known in the art such as by mechanically rotating a magnet.

The magnetic stirrer 2 is preferably battery powered with its activation by means of a button 4. The magnetic stirrer 2 may be permanently integrated into the bottom of the container 1 or it may be selectively detachable, for example by a friction fit, either surface to surface friction or by means of a lip engaging in a resilient (e.g. silicone) groove, or being threaded so as to be screwed onto the container, or by screws. In the embodiment illustrated in FIG. 1, the container has a principal wall 6 that extends to a wall bottom 8. Stirrer 2 comprises a body 10 and an upper extension 12 that fits in the bottom portion of the container and extends above the wall bottom 8.

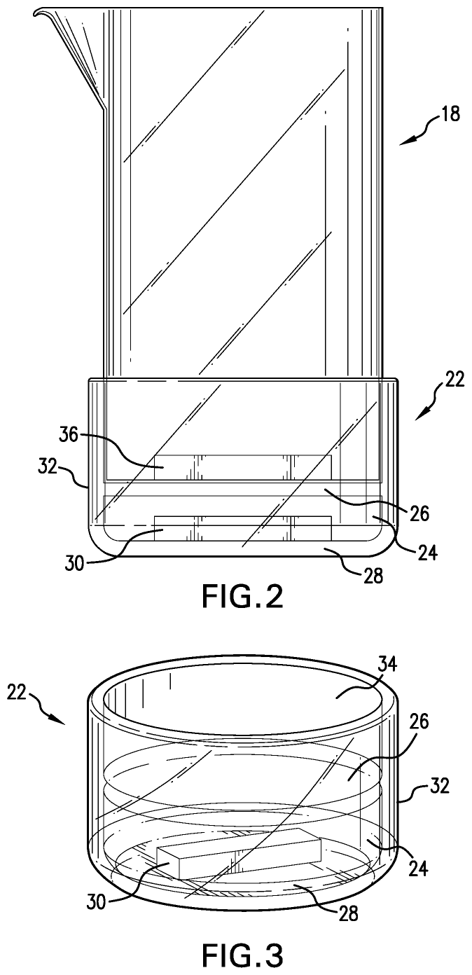

The container 1 generally has a base 14, an opening defining a top 16, and a wall 6 extending between the wall bottom 8 and the opening 16. The container 1 may vary in shape and size. For example, the container may be a beverage container 1 as shown in FIG. 1 or a laboratory flask 18 as shown in FIG. 2.

FIG. 1 shows the container 1 and magnetic stirrer 2 assembled together with a stirring implement 20 placed into the container 1. The stirring implement 20 comprises at least one magnet dipole for enabling it to magnetically couple to the magnetic stirrer 2 so that the stirring implement 20 rotates under the influence of rotation of the magnet that is within the stirrer 2. As the stirrer is attached to the container in this embodiment, the magnet within the stirrer is captive in relation to the container.

In operation, once mixing is complete the mixed solution in the container 1 may be poured without first removing the stirring implement 20. The magnetic stirrer 2 magnetically couples with the stirring implement 20 across the base 14 to magnetically retain the stirring implement 20 in close proximity to the base 14. Such magnetic coupling overcomes gravity and entrainment of the solution which would typically cause the stirring implement 20 to spill out of the container during pouring.

FIGS. 2 and 3 show an alternative embodiment of the invention. In the alternative embodiment, a base unit 22 is attached to the bottom of the container 18, which in this embodiment is depicted as a flask. In contrast to the magnetic stirrer 2 shown in FIG. 1, the base unit 22 shown in FIG. 2 is not an electrically powered magnetic stirrer. Instead, the base unit 22 has a compartment 24 preferably having a substantially flat top surface 26 and a substantially flat bottom surface 28. The flat top surface 26 enables the base unit 22 to come into close contact with the flat bottom of a container 18. It will be appreciated that the base unit 22 may vary in size and shape depending on the type of container it is designed to couple with. For example, if the container is a beverage container or tumbler, the base unit 22 would preferably be cylindrical in shape and roughly the size of the bottom of such a beverage container or tumbler.

Retained within the compartment 24 is a magnet 30. The magnet 30 is free to rotate in a plane parallel to the substantially flat top surface 26. While the magnet 30 in FIGS. 2 and 3 is shown as a rectangular bar magnetic, it may vary in shape provided that it is rotatable within the compartment 24.

The base unit 22 may be attached permanently to the bottom of the container 18 or may be selectively detachable from the base of the container 18. It will be appreciated that the base unit 22 may be selectively detachable by various means including those means described above in the container and magnetic stirrer embodiment of the invention shown in FIG. 1.

Referring to FIG. 3, the base unit 22 could be attached to different containers. As shown in FIG. 3, the body 32 of the base unit 22 has a collar 34 extending upwards from a compartment 24 housing a magnet 30. The collar 34 may be dimensioned to accommodate a close fit of a container. Alternatively, the body 32 of the base unit 22 could have one or more extensions extending upwards from it such that the walls of a container fit between the one or more extensions.

In operation, the base unit 22 and container 18 assembly are placed over a separate magnetic stirrer. The magnetic stirrer contains or has means to create a spinning magnetic dipole which generates a rotating magnetic field. The rotating magnetic field created by powering the magnetic stirrer causes the captive magnet 30 contained within the compartment 24 to rotate. An unattached magnetic stirring implement 36 located in the container will magnetically couple with the magnet 30 contained within the compartment 24 of the base unit 22. Accordingly, when the magnet 30 within the base unit 22 is spinning, the magnetic stirring implement 36 will also spin within the container as a result of magnetic coupling across the stirrer and the captive magnet 30. The captive magnet 30 acts as the means to cause the separate magnetic stirring implement 36 to rotate.

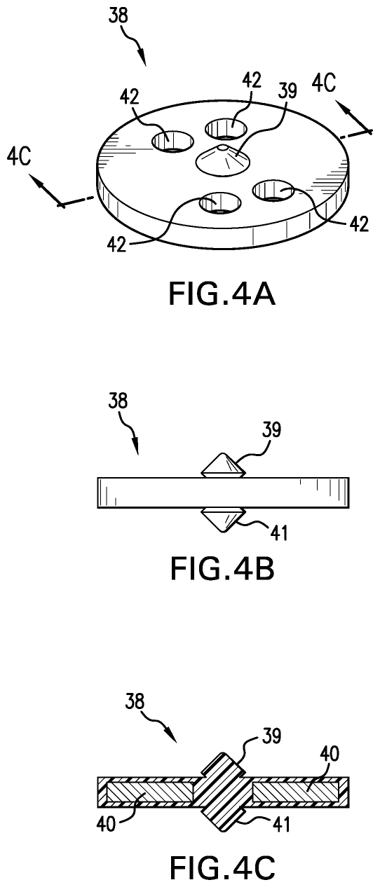

Various stirring implements can be used with the containers described herein. For example, rod-shaped magnetic stirring bars can be used. The inventor has determined that a disc-shaped stirring implement 38 as shown in FIGS. 4A-4C may also be used. The disc 38 has a magnetic dipole. FIG. 4B shows for example two internal magnets 40. It has been found that a single long magnet results in more effective stirring than two smaller spaced magnets.

The stirring implement 38 may also have protrusions and/or apertures to assist in the stirring of the contents of a container. The apertures may be sized to accommodate the base of a drinking straw such that the straw also rotate during stirring and would contribute to mixing. The number and size of apertures may vary. For example, FIG. 4A shows four circular apertures 42.

The disc may also have a projection on one or both sides at or near the centre of the disc. In FIGS. 4B and 4C, the disc is shown with two such protrusions 39, 41 on opposed sides of the disc. As a result of the protrusions, less of the disc surface is in contact with the bottom of container during operation. This reduces the friction between the disc and the container and improves the spinning of the disc.

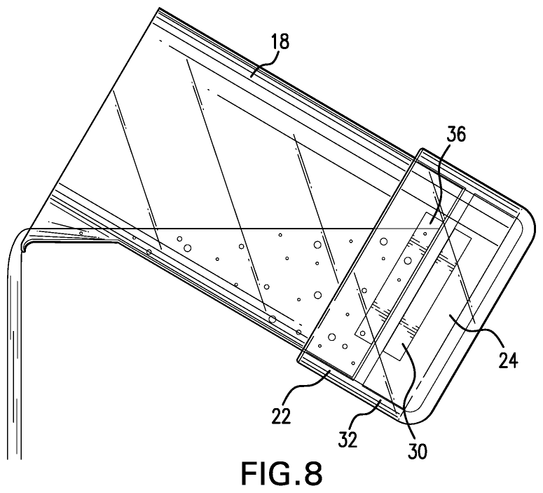

In both the attachable magnetic stirrer embodiment and the passive magnet compartment embodiment, magnetic coupling retains the stirring element when the container is tipped for pouring or drinking as suggested by FIG. 8.

For example in a chemistry laboratory, a user need not use a retriever for the stir bar prior to pouring the contents. Instead, the user may immediately pour the contents of the container without fear of the stir bar falling out. In a food application, if eggs are mixed for scrambling, the mixture can be immediately poured into a heated pan after mixing.

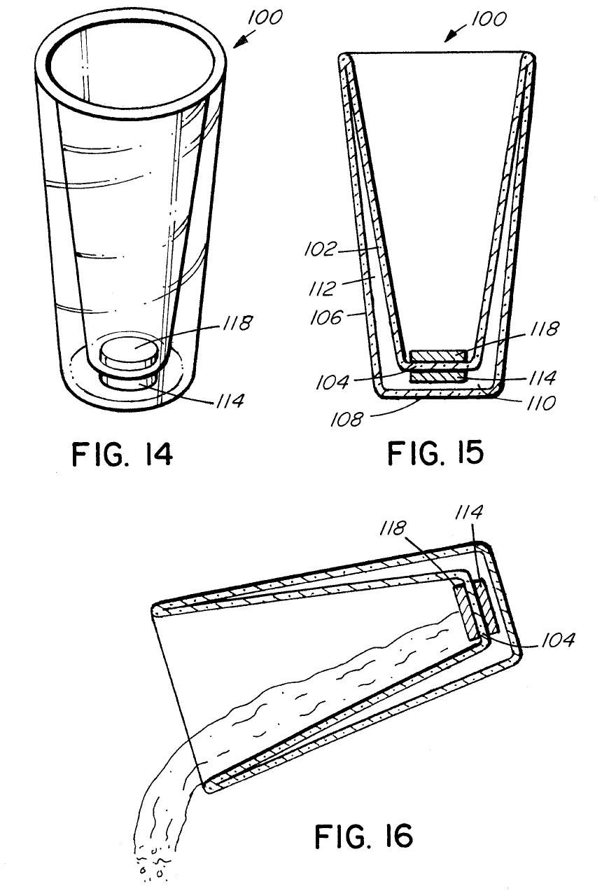

FIGS. 14 to 16 show another embodiment of the invention. A double walled container 100 has an interior wall 102, an interior bottom 104, an exterior wall 106, and an exterior bottom 108. A bottom space 110 is located between the interior bottom 104 and the exterior bottom 108 and a side space 112 is located between the interior wall 102 and the exterior wall 106. The bottom space 110 and side space 112 may be in fluid communication with one another. A captive magnet 114 is located within the bottom space 110 of the double walled container 100 such that it is capable of rotating in a plane parallel to the interior bottom 104.

In operation, the double walled container 100 is placed over or attached to a magnetic stirrer. The magnetic stirrer contains or has means to create a spinning magnetic dipole which generates a rotating magnetic field. The rotating magnetic field created by powering the magnetic stirrer causes the captive magnet 114 contained within the bottom space 110 to rotate. An unattached magnetic stirring implement 118 located in the container will magnetically couple with the captive magnet 114 contained within the bottom space 110. Accordingly, when the captive magnet 114 within the bottom space 110 is spinning, the magnetic stirring implement 118 will also spin within the container as a result of magnetic coupling across the stirrer and the captive magnet 114. The captive magnet 114 acts as the means to cause the separate magnetic stirring implement 118 to rotate.

As shown in FIG. 16, during the pouring or drinking of the container contents, the captive magnet 114 magnetically retains the magnetic stirring implement 118 adjacent to the interior bottom 104 of the container 100.

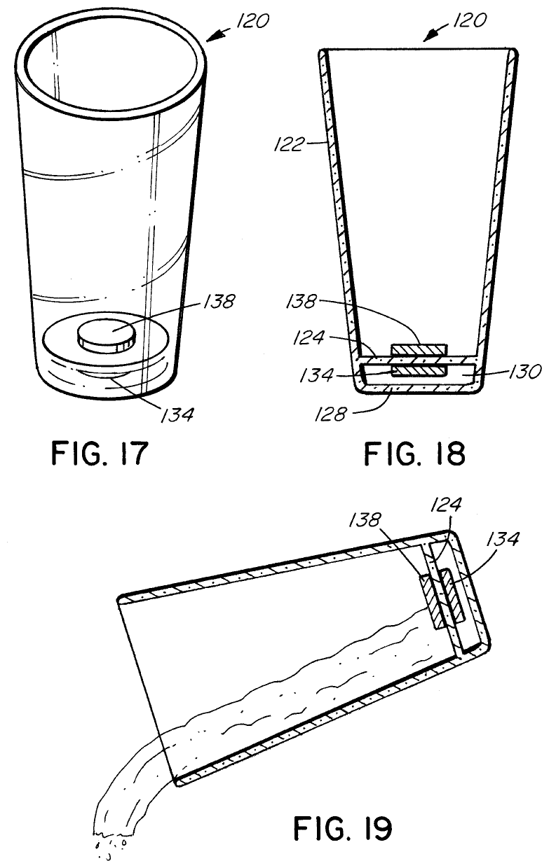

FIGS. 17 to 19 show another embodiment of the invention. A single walled container 120 has wall 122, an interior bottom 124, and an exterior bottom 128. A bottom space 130 is located between the interior bottom 124 and the exterior bottom 128. A captive magnet 134 is located within the bottom space 130 of the single walled container 120 such that it is capable of rotating in a plane parallel to the interior bottom 124.

In operation, the single walled container 120 is placed over or attached to a magnetic stirrer. The magnetic stirrer contains or has means to create a spinning magnetic dipole which generates a rotating magnetic field. The rotating magnetic field created by powering the magnetic stirrer causes the captive magnet 134 contained within the bottom space 130 to rotate. An unattached magnetic stirring implement 138 located in the container will magnetically couple with the captive magnet 134 contained within the bottom space 130. Accordingly, when the captive magnet 134 within the bottom space 130 is spinning, the magnetic stirring implement 138 will also spin within the container as a result of magnetic coupling across the stirrer and the captive magnet 134. The captive magnet 134 acts as the means to cause the separate magnetic stirring implement 138 to rotate.

As shown in FIG. 19, during the pouring or drinking of the container contents, the captive magnet 134 magnetically retains the magnetic stirring implement 138 adjacent to the interior bottom 124 of the container 120.

In another embodiment of the invention, the magnetic mixing means may assist in steeping tea. The desirable steeping time for tea may vary depending on the type of tea and the taste preferences of the tea drinker. It has been found that mixing hot water while steeping tea greatly reduces the time it takes to obtain the desired concentration.

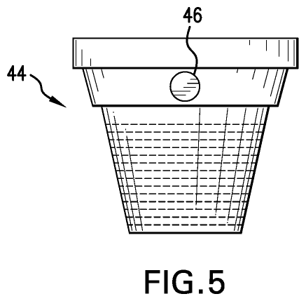

FIG. 5 shows a basket style of tea infuser 44 for use with tea leaves. The infuser 44 comprises at least one magnet 46 which in the embodiment shown is secured to the exterior surface of the infuser 44.

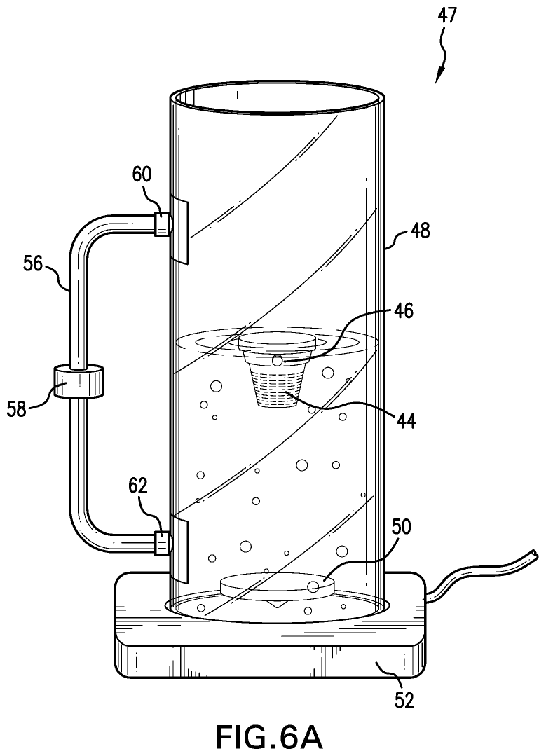

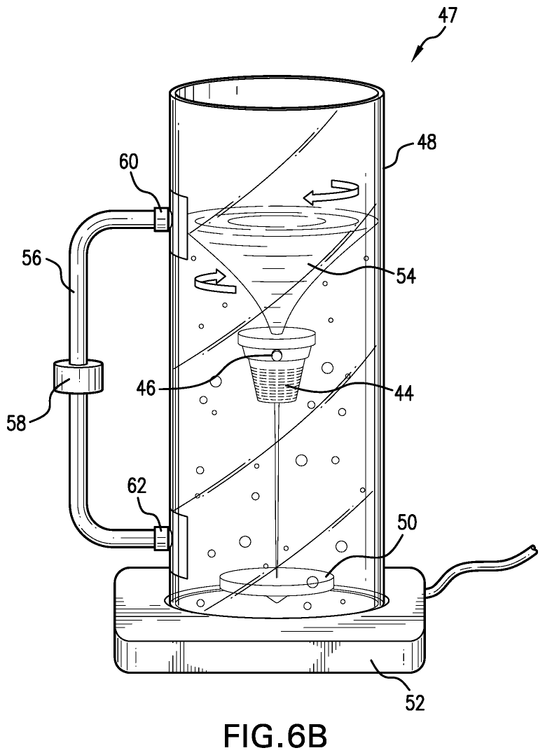

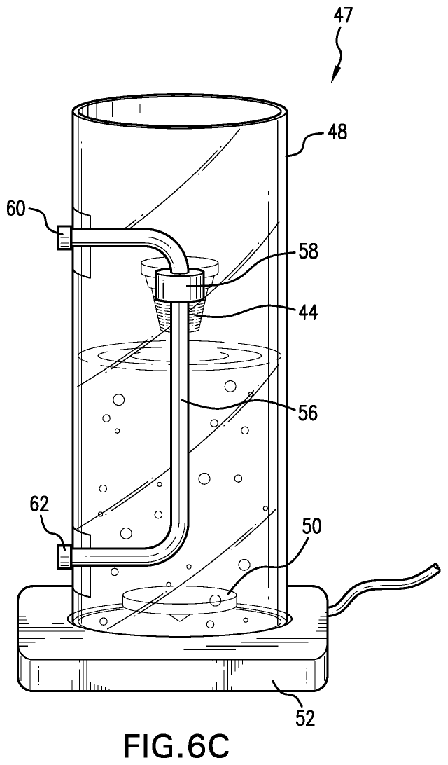

FIG. 6A shows the tea infuser 44 placed in a container 47. In one embodiment, the tea infuser may float in water or other liquid contained in the container. A magnetic stirring implement 50 is placed in the container 47 and rests at the bottom of the container 47. The container is placed on top of a magnetic stirrer 52. In alternate embodiments, a magnetic stirrer or a base unit containing a magnet may be attached to the bottom of the container as shown in FIGS. 1 and 2 respectively.

Powering the magnetic stirrer 52 causes the magnetic stirring element 50 to spin at the bottom of the container. Depending on the speed of rotation, a vortex 54 may be created in the solution being mixed. Referring to FIG. 6B, it has been found that when a vortex is created, the floating tea infuser 44 will fall downwards and into the solution. During mixing, the solution permeates through the tea infuser more rapidly than without mixing, resulting in a shorter steeping time and less heat loss before the tea can be drunk or poured.

A magnetic means of removing the infuser is appreciated by reference to FIGS. 6A-6C. A container has a handle 56 connected to the peripheral surface 48 of the container. A magnet 58 is connected to the handle in such a manner that the magnet is may slide vertically on the handle. The handle 56 has pivoting means, such as one or more hinges 60, 62 for pivoting the handle 56 in relation to the container. Once the tea has steeped, a user pivots the handle 56 toward the surface 48 of the container, raises or lowers the magnet 58 along the handle 56 so as to bring the magnet 58 into proximity with the surface 48 of the container. The magnet 58 magnetically couples to the magnet 46 on the tea infuser 44 and the user may then slide the magnet 58 up the handle in order to remove the tea infuser 44 from the solution in the container as shown in FIG. 6C.

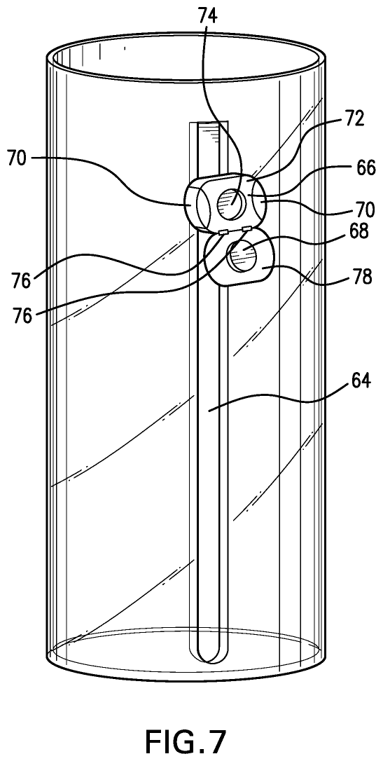

Referring to FIG. 7, in an alternate embodiment for removing a tea infuser, the container has a vertical channel 64 located on its surface. A magnetic housing 66 is slidably retained with the vertical channel 64 to hold a magnet 68 which magnetically couples across the container wall to the magnet 46 on the tea infuser located within the container. Accordingly, a user may withdraw the tea infuser from the water and bring it to the top of the container for manual removal.

The magnetic housing 66 may vertically slide in the channel 64 by various means. For example and as shown in FIG. 7, the magnetic housing 66 may have buttons 70 to lock and unlock the housing 66 in place along the channel. The depression of the buttons 70 allows the housing 66 to slide up and down. When the buttons 70 are released, the housing 66 locks into position on the vertical channel 64.

The magnetic housing 66 may also vary in size, shape, and configuration. For instance, the magnetic housing 66 shown in FIG. 7 has a body 72 comprising an aperture 74. The body 72 is connected by one or more hinges 76 to a cap 78. The magnet 68 is connected to the cap 78 such that when the cap 78 is closed over the body 72, the magnet 78 protrudes into the aperture 74 and magnetically couples to a tea infuser inside the container. The movement of the magnet 78 away from the aperture 74 causes the magnet 78 to magnetically decouple with one or more magnets on the infuser.

In operation, a user may use the invention to steep tea to a desired strength. The user places hot water, a magnetic stirring implement, and an infuser holding tea into a container. A magnetic stirrer under the container is powered to create a rotating magnetic field, which causes the magnetic stirring implement to spin within the container. As discussed above, the mixing reduces the time required to steep tea since water will permeate through the infuser at a more rapid rate compared to steeping without mixing. Lastly when the desired strength or concentration is achieved, the user raises the infuser through magnetic coupling means across the container walls. This prevents over-steeping and reduces the risks or burning. If the user wants to continue to steep the tea afterwards, the infuser may be lowered or dropped downwards.

In a further alternative embodiment of the invention, the container has a ferromagnetic ring around the circumference of the container. The ferromagnetic ring is preferably located at or near the top opening of the container, but may also be located slightly down the wall of the container.

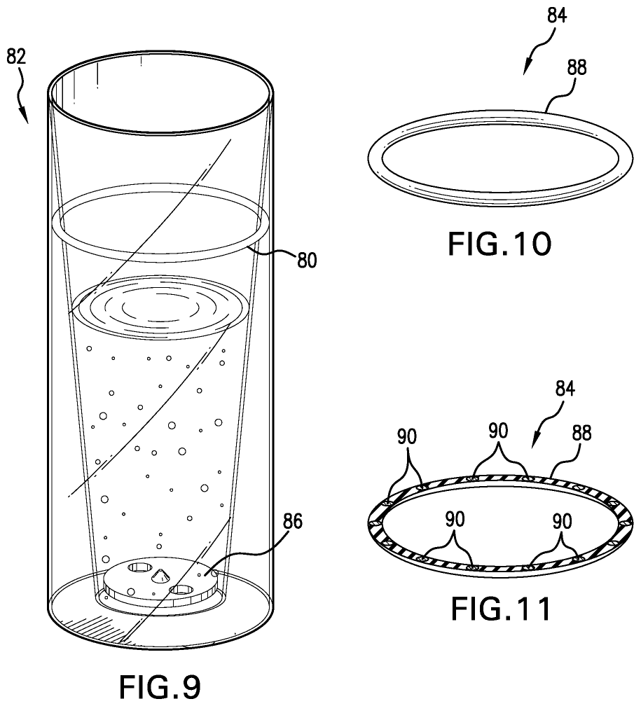

Referring to FIG. 9, the ferromagnetic ring 80 may be integrated between opposing walls of the container 82. Although ferromagnetic ring 80 is shown as being one continuous ring, the container may contain a series of separate magnets.

In another embodiment, the ferromagnetic ring may be removable from the container. For example, the removable ferromagnetic ring 84 shown in FIGS. 10 and 11 may be placed over a container and be stretchably retained on the container. Removable ferromagnetic ring 84 has a ring-shaped casing 88 that may be flexible. The casing 88 can be made of food grade silicone or other food grade polymers. The removable ferromagnetic ring 84 contains a series of internal magnets 90 within the casing 88.

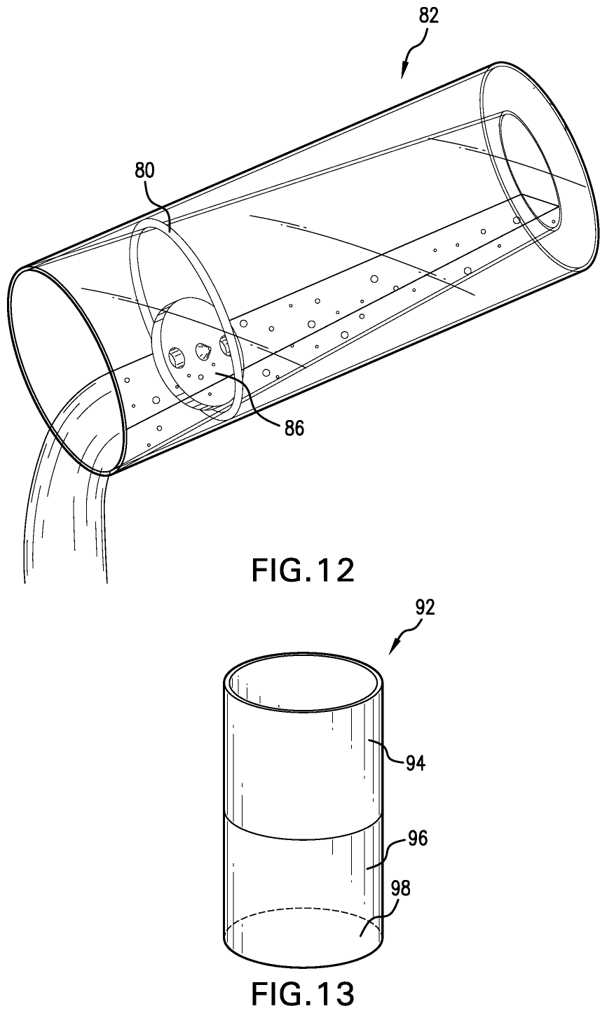

FIG. 12 shows the use of container 82 shown in FIG. 9. The ferromagnetic ring 80 magnetically couples to a magnetic stirring implement 86 placed into the container when the contents of the container are poured out and are entraining the stirring implement 86. This prevents the stirring implement 86 from falling past the ring 86. As the stirring implement 86 moves towards the opening of the container, it eventually becomes magnetically coupled to the ferromagnetic ring 80. This prevents the splashing caused by the magnetic stirring implement 86 that would otherwise occur. Additionally, if the container is a drinking vessel, the magnetic coupling between the ferromagnetic ring 80 and the stirring implement 86 prevents the stirring implement from becoming a choking hazard.

The removable ferromagnetic ring 84 shown in FIGS. 10 and 11 retains stirring implement 86 in a similar manner as integrated ferromagnetic ring 80 shown in FIG. 9. The series of magnets 90 within the casing 88 of ring 84 produce a magnetic field across the walls of a container which retains the magnetically stirring implement during pouring.

In further embodiment of the invention, a portion of the walls of the container are magnetic. For example, if the container is made of stainless steel, a portion of the walls may be made of magnetic stainless steel such as ferritic stainless steel. If the bottom of the container or the lower portion of the walls are also made of a magnetic material, then undesired magnetic coupling between the bottom or lower portion of the wall and the magnetic stirring implement or magnetic stirrer may occur. Accordingly, the bottom and lower portion of the container are preferably made of a nonmagnetic material.

The magnetic portion is preferably located on the top half of the container. For example, the magnetic portion may be at or near the top opening of the container. The magnetic portion creates a magnetic field around the full circumference of the container so that so that the magnetic stirring implement will be magnetically retained during pouring irrespective of the orientation of the container.

FIG. 13 shows a container 92 having an upper magnetic portion 94, a lower nonmagnetic portion 96, and a nonmagnetic bottom 98. It will be appreciated that while the upper magnetic portion 94 shown in FIG. 13 is the top half of the container 92, the portion may vary in size, shape, and location. For instance, the magnetic portion may be a narrower band located on the top half of the container.

In a method of mixing one or more substances, a magnetic mixing implement and one or more substances to be mixed are placed into a container. In the example of a beverage, the substances to be mixed may be water and flavouring in the form of a liquid or solid. A magnetic stirrer under the bottom of the container is powered to create a rotating magnetic field across the bottom of the container. This causes the magnet mixing implement to spin and the substance(s) within the container to mix to create a mixed substance. Once mixing is complete, the mixed substance contained within the container is poured out.

A ferromagnetic ring or series of magnets integrated with or placed around the walls of the container magnetically couple with the magnetic stirring implement. Alternatively, the magnetic stirring implement may be retained by magnetically coupling to a magnetic portion of the walls of the container.

In any embodiment of the method using a magnetic stirring implement retaining element that is removable from the container, the element must be inserted in or placed onto the container prior to the step of pouring the mixed substance. The element may be placed on the container before or after the one or more substances to be mixed are placed into the container. By way of example, a stretchable ferromagnetic ring having a stretchable ring-shaped casing and series of internal magnets may be used. In the example, the stretchable ferromagnetic ring is stretched and placed about the walls of the container. Once released, the stretchable ferromagnetic ring is stretchably retained about the outer walls of the container and creates a magnetic field extending across the wall of the container for retaining the magnetic stirring implement during pouring.

Various embodiments of the invention may be used to mix beverages, food substances, laboratory solutions, and other liquids or solids.

Alternatively, various embodiments of the invention may be used to aerate wine. For instance, in a method of aerating wine, wine is poured into a container. The container may be a decanter. A magnetic stirring implement is placed in the container and a magnetic stirrer is powered under the bottom of the container to cause the magnetic stirring implement to spin and stir the wine. The stirring results in a greater rate of aeration compared to an equal volume of wine contained in the same container that is unstirred.

Once a desired amount of aeration is obtained, the wine may be poured from the container without first removing the magnetic stirring implement. During pouring, the magnetic stirring implement is magnetically retained within the container. The magnetic stirring implement may be magnetically retained by a magnetic stirrer 2 attached to the container as shown in FIG. 1, by another magnet 30 retained in a base unit 22 attached to the bottom of the container as shown in FIG. 2, by a ferromagnetic ring 80 located between the walls of the container as shown in FIG. 9, by a stretchable ferromagnetic ring 88 as shown in FIG. 10 placed around the walls of the container, by an upper magnetic portion 94 of the container as shown in FIG. 13, by a captive magnet 114 of the container as shown in FIG. 15, or by a captive magnet 134 of the container as shown in FIG. 18.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

What is claimed is:

1. A container assembly for receiving and mixing fluids comprising:
a container having a bottom;
a base unit comprising an enclosure;
a captive rotatable magnet unattached to said enclosure and retained within said enclosure; and
an unattached magnetic stirring implement for resting on said bottom and for coupling to said captive rotatable magnet;
wherein said implement is adapted to rotate when said captive rotatable magnet rotates and said assembly is configured such that said implement is magnetically retained by coupling to said captive rotatable magnet when said container is tilted for pouring the contents from said container.

2. The container assembly of claim 1 wherein said base unit is detachable from said container.

3. The container assembly of claim 1 wherein said stirring implement is a disc comprising at least one magnet.

4. The container assembly of claim 3 wherein said disc includes at least one aperture for assisting in the mixing of contents in said container.

5. The container assembly of claim 3 wherein said disc includes at least one protrusion for assisting in the mixing of contents in said container.

6. The container assembly of claim 3, said disc having a substantially flat surface with a central protrusion for decreasing the friction between said disc and said bottom of said container.

7. The container assembly of claim 1 wherein said stirring implement is a bar comprising at least one magnet.

8. The container assembly of claim 1 wherein said container is a double walled container.
